(19) United States
(12) Patent Application Publication
(10) Pub. No.: US 2009/0125922 A1
(43) Pub. Date: May 14, 2009

(54) DISC DRIVE APPARATUS

(76) Inventors: Hiroyuki YOKOE, Ehime (JP); Takeshi OOSORA, Ehime (JP)

Correspondence Address: WENDEROTH, LIND & PONACK L.L.P., 1030 15th Street, N.W., Suite 400 East, Washington, DC, 20005-1503, US

(21) Appl. No.: 12/238,962

(22) Filed: Sep. 26, 2008

(30) Foreign Application Priority Data
Oct. 9, 2007 (JP) 2007-263803
Oct. 10, 2007 (JP) 2007-264887

(51) Int. Cl. G11B 17/04

(52) U.S. Cl. 720/601

(57) ABSTRACT

A disc drive apparatus includes an external frame 100 having a disc insertion opening 101, right and left arms 400 and 401, and a spring S10. The right and left arms 400 and 401 holds an outer peripheral portion of an optical disc 102 which is inserted from the disc insertion opening 101 as they rotate along the outer peripheral portion of the disc 102 in accordance to the position of the disc inserted from the disc insertion opening 101. The spring S10 applies forces such that ends of the pair of right and left arms 400 and 401 on the disc insertion opening side pull each other.

### CROSS-REFERENCE TO RELATED APPLICATIONS

This application claims priority to Japan Patent Application Nos. 2007-263803 and 2007-264887. The entire disclosures of Japan Patent Application Nos. 2007-263803 and 2007-264887 are hereby incorporated herein by reference.

### BACKGROUND OF THE INVENTION

1. Field of the Invention

The present invention relates to a disc drive apparatus of a slot-in type to which disc type recording media, including read-only discs such as CDs, DVDs and the like and discs for recording/reproduction such as CD-Rs, DVD-Rs and the like, can be loaded.

2. Description of the Related Art

Conventionally, disc drive apparatuses to/from which disc type recording media such as optical discs can be loaded/ejected in a slot-in method have been used.

For example, Japanese Laid-open Patent Publication No. 2006-331487 discloses a disc drive apparatus which includes a slider for sliding an optical disc inserted from a disc insertion slot in a direction substantially orthogonal to a direction of insertion, disc loading means (for example, six rollers), pinions, and a drive motor for driving these parts so as to rotate reversibly in order to draw the optical disc to a position above a turn-table with the optical disc being slid in a surface direction. The disc drive apparatus further includes a main slide cam which is slid in a direction substantially orthogonal to the sliding direction of the slider, a sub-slide cam, first and second biasing means, rack, cam grooves, and cam driven pins.

In many optical disc drive apparatuses (an example of disc drive apparatuses), a device for automatically loading/ejecting a naked optical disc which is called slot-in type is employed for achieving a thinner and lighter device (see, for example, Japanese Laid-open Patent Publication No. 11-296949).

Optical discs having various shapes are sold. For example, discs having a shape of star, a shape of flower, and a shape of business card are known (hereinafter, such discs are referred to as irregular shaped discs).

When such an irregular shaped disc is inserted into an optical disc drive apparatus having a loading mechanism of the slot-in type, the disc and a housing of the disc drive apparatus may be damaged due to a mechanical structure of the slot loading mechanism.

Accordingly, some techniques to prevent damage to the disc or disorder of the disc drive reproducing apparatus when an irregular shaped disc is inserted into a device having a loading mechanism of the slot-in type have been known conventionally (see, for example, Japanese Laid-open Patent Publication No. 2002-279716). In the conventional disc drive apparatus disclosed in Japanese Laid-open Patent Publication No. 2002-279716, an irregular shaped disc is detected by using a switch and a sensor or the like to eject the detected disc.

Herein, a method for detecting a disc in the conventional disc drive apparatus is described simply with reference to FIGS. 27 through 30.

FIG. 27 is a schematic diagram showing a loading operation when a standard disc is inserted into a conventional optical disc drive apparatus. In the conventional optical disc drive apparatus, as a disc is inserted from the disc insertion opening, the insertion position of the disc changes from position 0 to position 1, and then, to position 2.

As the disc is inserted, a switch 1, a switch 2, a sensor 3, and a switch 4 are turned on in a predetermined order within a predetermined time period in accordance with the insertion position of the disc. In this way, the inserted disc is confirmed to be a standard disc. FIG. 28 is a timing chart showing when the switches are turned on. In FIG. 28, the switch 1, the switch 2, the sensor 3, and the switch 4 are turned on in a predetermined order within a predetermined time period.

FIG. 29 is a schematic diagram showing a loading operation when an irregular shaped disc is inserted into a conventional optical disc drive apparatus. When the irregular shaped disc is inserted, the switch 1, the switch 2, the sensor 3, and the switch 4 are turned on not in the predetermined order or timing in accordance with the change in the insertion position of the disc. Thus, it is determined that the irregular shaped disc is inserted, and the device is shifted to the ejecting operation.

FIG. 30 is a timing chart showing when the switches are turned on when the irregular shaped disc is inserted. In FIG. 30, the switch 2 is turned on not in the predetermined order. Accordingly, it is detected that the irregular shaped disc is inserted, and the detected irregular shaped disc is ejected.

### SUMMARY OF THE INVENTION

However, the above conventional disc drive apparatus has the following problems.

In the disc drive apparatus disclosed in Japanese Laid-open Patent Publication No. 2006-331487, No. 11-296949 and No. 2002-279716, an optical disc is held at an outer peripheral portion using a plurality of rollers or the like having a drum-like shape and is drawn along a horizontal direction. Then, the rollers are moved away from the disc outer peripheral portion to move the optical disc downward, and the optical disc is chucked to the turntable. In such a structure, many number of parts including rollers are required in order to maintain ejecting stroke of optical discs. The disc drive apparatus already includes members such as slider, main slide cum, sub slide cum, and first and second biasing means. Since the number of the parts further increases, it becomes difficult to make the device smaller and thinner.

An object of the present invention is to simplify a structure for loading a disc along a surface direction to a turntable in a disc drive apparatus in order to provide a device that can be made smaller and thinner.

A disc drive apparatus according to the first invention includes a frame portion having a disc insertion opening, a pair of arm members on right and left sides, and a biasing member. The pair of arm members on the right and left sides rotate along an outer peripheral portion of a disc inserted from the disc insertion opening in accordance with the position of the disc and hold the outer peripheral portion of the disc. The biasing member applies forces such that respective ends of the pair of the arm members on the disc insertion opening side pull each other.

In this example, a mechanism in which a pair of arm members which are applied forces such that respective ends on the disc insertion opening side pull each other are used to automatically pull or push a disc along a surface direction is employed.

With such a structure, for example, for inserting a disc, the disc inserted from the disc insertion opening can be easily drawn into the device by a force applied by the biasing member by only pushing the disc to a position where a diameter portion of the disc passes between the ends mentioned above. On the other hand, for ejecting the disc, the disc can be easily ejected outside the device by a force applied by the biasing member by only carrying the disc with an ejecting mechanism or the like to the position where the diameter portion of the disc passes between the ends mentioned above.

As a result, the disc can be carried along the surface direction without locating a plurality of rollers or the like in the device in order to carry the disc in the surface direction. Therefore, a device can be made smaller and thinner by decreasing the number of the pats with a sufficient ejecting stroke being secured.

A disc drive apparatus according to the second invention is a disc drive apparatus according to the first invention further including a substrate and a disc holder. The substrate has a first groove(s) formed so as to extend from the disc insertion opening side toward the further side. The disc holder moves in a direction the disc is inserted as the disc is inserted or removed, and has a second groove(s) formed along a direction substantially vertical to the insertion direction. The arm members have a plurality of boss portions which move within the first and the second grooves in the state being fitted to the first and the second grooves.

In this example, a structure in which a plurality of boss portions provided on the arm members are fitted to the first and the second grooves respectively formed on the substrate and the disc holder provided in the disc drove device and are moved within the grooves is employed.

With such a structure, for inserting a disc, for example, the arm members can be rotated along the outer peripheral portion of the disc in accordance with the disc insertion position by moving the boss portions of the arm members along the first and the second grooves and the disc can be held. On the other hand, for ejecting the disc, the arm members can be rotated so as to guide the disc in the ejecting direction by moving the boss portions of the arm members along the first and the second grooves.

A disc drive apparatus according to the third invention is a disc drive apparatus according to the first or second invention further including a pair of rod portions on right and left sides and a moving mechanism. The pair of rod portions have a third groove(s) including a step in a direction vertical to a surface of the disc. The moving mechanism moves the pair of rod portions backward and forward in the disc insertion direction. The disc holder has a rib(s) which protrudes in a direction crossing the insertion direction in the disc surface direction and moves in the state being fitted to the third groove.

In this example, the rib of the disc holder moves within the third groove by moving the pair of rod portions on the right and left sides backward and forward in the disc carrying direction after the disc is carried to the position where the center hole comes above the clamped position.

With such a structure, the disc holder for holding the disc can be moved upward and downward in the direction vertical to the surface direction by moving the pair of rod portions on the right and left sides with the third groove being formed thereon backward and forward in the insertion direction by the moving mechanism. As a result, the disc carried to the position above the clamped position can be moved upward and downward with the disc holder to readily shift to the clamped state and release the clamped state.

A disc drive apparatus according to the fourth invention is a disc drive apparatus according to any one of the first through third inventions further including a retraction mechanism for retracting the arm members outward in the radial direction of the disc after the disc is shifted to the clamped state.

In this example, with the disc being shifted downward to the clamped position, the pair of the arm members on the right and left sides are retracted outward in the radial direction by the retraction mechanism to release the disc.

With such a structure, after the disc is moved to the clamped position, the disc can be released from the pair of arm members which have carried the disc to the predetermined position. As a result, information can be read and/or written from and/or to the disc at the clamped position.

A disc drive apparatus according to the fifth invention is a disc drive apparatus according to any one of the first through fourth inventions further including an ejecting mechanism. The ejecting mechanism drives the arm members so as to move the disc from the disc clamped position to a position where a diameter portion of the disc passes between the ends of the pair of the arm members on the disc insertion opening side, which are biased by the biasing member.

In this example, for smoothly ejecting the disc in the clamped state, the disc is moved in the surface direction by the ejecting mechanism to the position where the disc can be automatically ejected by the above-mentioned biasing member (the position where the diameter portion of the disc passes between arm bosses 402 and 404).

With such a structure, the disc can be ejected to the position where the center hole can be seen from the clamped state even with a simple structure.

A disc drive apparatus according to the sixth invention is a disc drive apparatus according to any one of the first through fifth inventions in which at least one of the pair of the arm members on the right and left sides includes a disc detection element for detecting whether there is a gap to the outer peripheral portion of the disc. The disc drive apparatus further includes a disc determination section for determining whether the disc has a circular shape or not in accordance with a result of detecting the gap by the disc detection element.

In this example, when a disc is inserted from the insertion opening, the disc is moved into the device with the outer peripheral portion of the disc being held by the arm members on the right and left sides. At this time, the arm members move along the outer peripheral portion of the disc in accordance with the disc loading operation. Then, the disc detection element provided on a surface of the at least one of the pair of the arm members on the right and left sides, which opposes the outer peripheral portion of the disc, partially scans the outer peripheral portion of the disc. If a disc has a circular shape, a gap between the disc detection element and the outer peripheral portion of the disc does not change, and the disc detection element remains on, for example. If an irregular shaped disc such as a disc having a shape of star, flower, or the like is inserted, the gap between the disc detection element and the outer peripheral portion varies. Therefore, the output from the disc detection element changes from on to off, for example. As a result, by detecting change in the output from the disc detection element, whether the disc has a circular shape or not can be determined.

Furthermore, since the disc detection element is moved along the outer peripheral portion of the disc in accordance with the loading operation, whether the disc has a circular shape or an irregular shape can be determined by one detection element without using a plurality of detection elements. Thus, an irregular shaped disc can be detected easily without increasing the number of detection elements such as switches, sensors, or the like for detecting the shape of the disc.

A disc drive apparatus according to the seventh invention is a disc drive apparatus according to the sixth invention in which the disc detection element is located at a position of the at least one of the pair of the arm members on the right and left sides which opposes the outer peripheral portion of the disc.

In this example, the disc detection element is provided on only one of the pair of the arm members on the right and left sides. Thus, the number of the detection elements can be decreased.

A disc drive apparatus according to the eighth invention is a disc drive apparatus according to any one of the first through seventh inventions in which the arm member is a member having a substantially arc shape which abuts a non-recording surface of the disc including the outer peripheral portion and can hold the disc, and which moves the disc from the insertion opening to the inside of the device while moving along the outer peripheral portion of the disc during the loading operation.

In this example, the pair of the arm members on the right and left sides can have two functions: detection of the outer peripheral portion of the disc and holding the disc. The pair of the arm members on the right and left sides can be used as both the loading mechanism and the disc detection section for further simplifying the structure of the loading mechanism and the disc detection section.

### BRIEF DESCRIPTION OF THE DRAWINGS

FIG. 1 is a perspective view of an assembled optical disc drive apparatus according to an embodiment of the present invention.

FIG. 2 is an exploded perspective view of the optical disc drive apparatus of FIG. 1.

FIG. 3A is a plan view showing locations of arms and SWs of the optical disc drive apparatus of FIG. 1; FIG. 3B is a view along a direction of arrow Z; and FIG. 3C is a cross sectional view along line a-a.

FIG. 4 is a perspective view showing locations of rail plate and SWs of the optical disc drive apparatus of FIG. 1.

FIG. 5 is a plan view showing POS 0 state of the optical disc drive apparatus of FIG. 1.

FIG. 6 is a side view showing a state of the optical disc drive apparatus of FIG. 1 during loading.

FIGS. 7A through 7C are cross sectional views for illustrating the state of SW detection of the optical disc drive apparatus of FIG. 1.

FIG. 8 is a plan view showing POS 2 state of the optical disc drive apparatus of FIG. 1.

FIG. 9 is a plan view showing POS 4 state of the optical disc drive apparatus of FIG. 1.

FIG. 10 is a perspective view showing POS 0 state of the optical disc drive apparatus of FIG. 1.

FIGS. 11A and 11B are side views of the optical disc drive apparatus of FIG. 1 during the loading operation; and FIG. 11C is an enlarged view thereof.

FIG. 12 is a perspective view showing a structure of a disc clamp mechanism of the optical disc drive apparatus of FIG. 1.

FIG. 13 is a perspective view showing a drive transmission mechanism of the optical disc drive apparatus of FIG. 1 during disc ejecting.

FIG. 14 is an enlarged view of dotted circle X of FIG. 12.

FIG. 15 is an enlarged view of dotted circle Y of FIG. 13.

FIG. 16 shows side views and enlarged views of the optical disc drive apparatus according to the present invention during an eject operation.

FIG. 17 is an illustrative diagram showing a disc detection switch of the optical disc drive apparatus according to the present invention in position 0 state.

FIG. 18 is an illustrative diagram showing the disc detection switch of the optical disc drive apparatus according to the present invention in position 1 state.

FIG. 19 is an illustrative diagram showing the disc detection switch of the optical disc drive apparatus according to the present invention in position 2 state.

FIG. 20 is a schematic diagram showing the loading operation when a standard disc is inserted into the optical disc drive apparatus according to the present invention.

FIG. 21 is a diagram showing a normal timing chart when a standard disc is inserted.

FIG. 22 is a schematic diagram showing the loading operation when an irregular shaped disc is inserted into the optical disc drive apparatus according to the present invention.

FIG. 23 is a diagram showing abnormal timing chart when an irregular shaped disc is inserted.

FIG. 24 is a schematic diagram showing the loading operation when a disc is pulled out while it is being inserted into the optical disc drive apparatus according to the present invention.

FIG. 25 is a diagram showing abnormal timing chart when a disc is pulled out while it is being inserted.

FIG. 26 is a block diagram showing a structure of a control device.

FIG. 27 is a schematic diagram showing the loading operation when a standard disc is inserted into a conventional optical disc drive apparatus.

FIG. 28 is a diagram showing normal timing chart when a standard disc is inserted.

FIG. 29 is a schematic diagram showing the loading operation when an irregular shaped disc is inserted into a conventional optical disc drive apparatus.

FIG. 30 is a diagram showing abnormal timing chart when an irregular shaped disc is inserted.

### DETAILED DESCRIPTION OF THE INVENTION

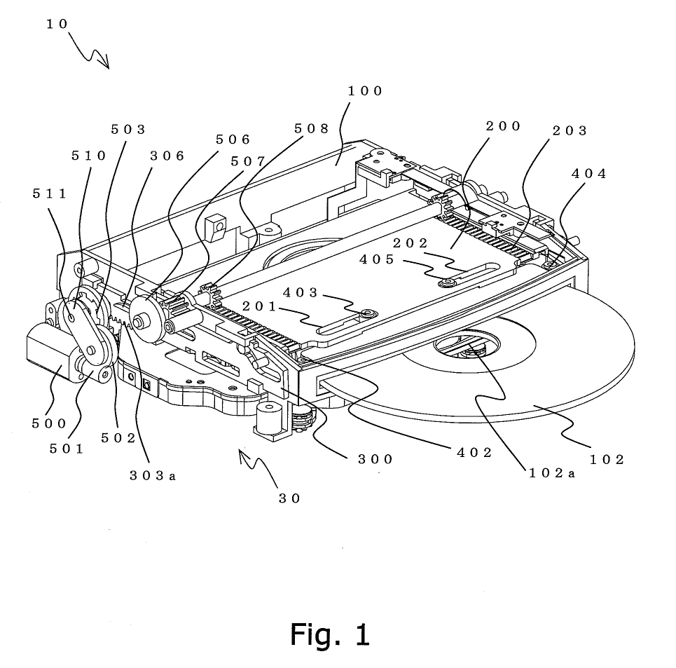

An optical disc drive apparatus (disc drive apparatus) 10 according to an embodiment of the present invention is described as follows with reference to FIGS. 1 through 26.

“Horizontal” and “vertical” directions as described in the following description refer to “horizontal” and “vertical” directions when the optical disc drive apparatus 10 is placed as shown in FIG. 1 and the like. Therefore, when the optical disc drive apparatus 10 is placed vertically, the horizontal direction refers to the actual “vertical” direction and the vertical direction refers to actual “horizontal” direction. Furthermore, “right and left” directions as described in the following description refer to right and left when the device is placed with the disc insertion direction being the front side.

### [Structure of Optical Disc Drive Apparatus 10]

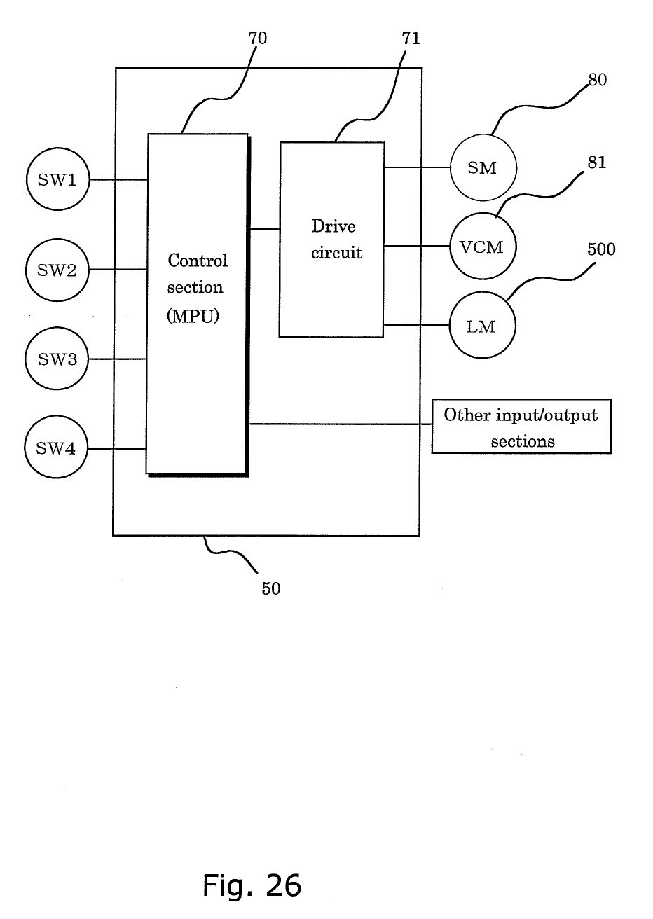

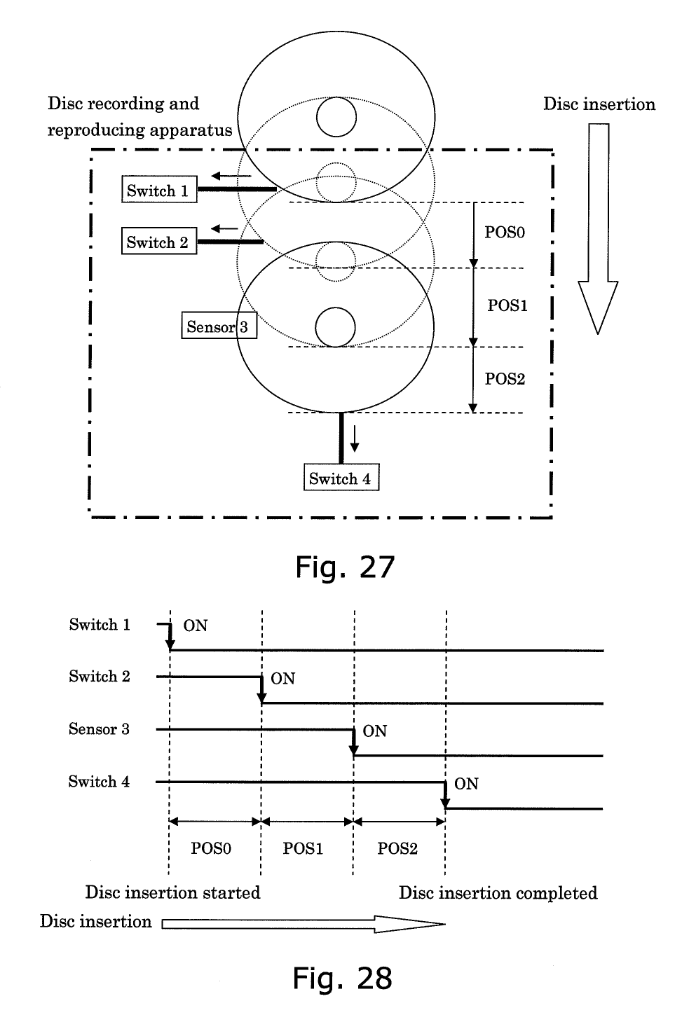

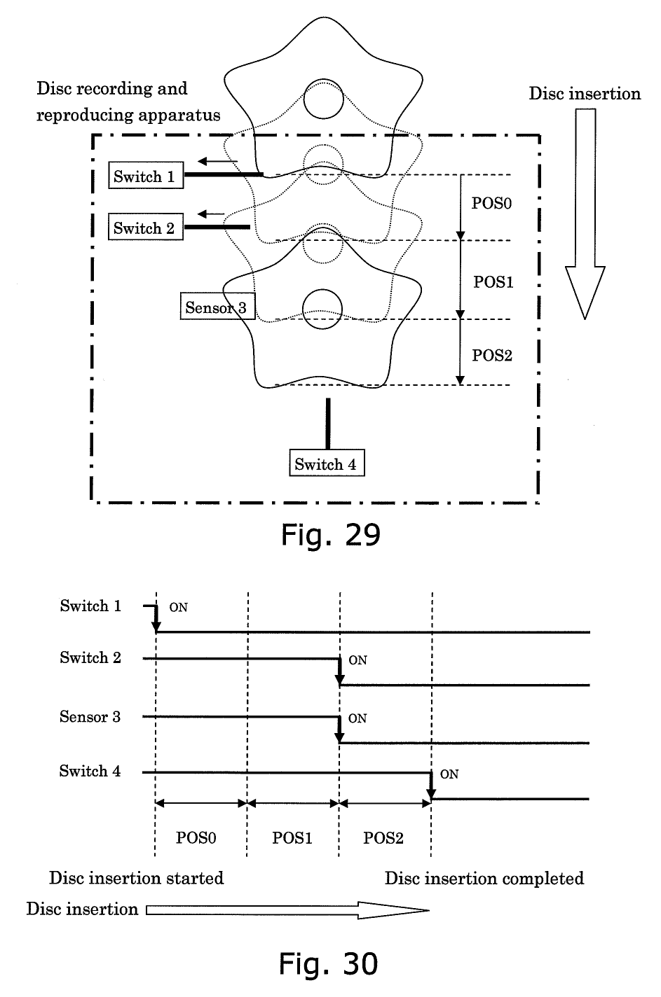

The optical disc drive apparatus 10 according to the present embodiment particularly includes a loading mechanism 20 which can load/eject an optical disc 102, which is read only disc such as DVD-R or the like, with the slot-in method. The optical disc drive apparatus 10 further includes a disc clamp mechanism 30 for clamping the loaded optical disc 102 and a control device (disc determination section) 50 for controlling an optical disc drive 103 and the loading mechanism 20 (see FIG. 26).

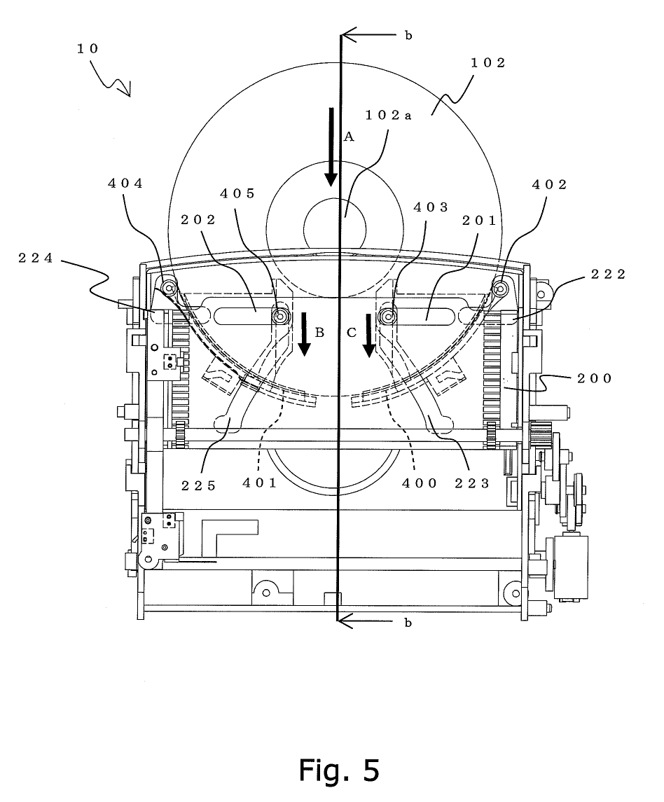

The loading mechanism 20 has a simple structure which includes four switches SW1 through SW4 and one motor. For ejecting the optical disc 102, the loading mechanism 20 carries the optical disc 102 to a position where its center hole 102a is exposed outside from a disc insertion opening 101 (see FIG. 5) to secure sufficiently long ejecting stroke. The structure of the loading mechanism 20 will be later described in more detail.

The disc clamp mechanism 30 is a mechanism which moves the optical disc 102 which has been carried to a predetermined position in a direction vertical to the disc surface and clamps the disc on a turntable 104. The structure of the disc clamp mechanism 30 will be later described in more detail.

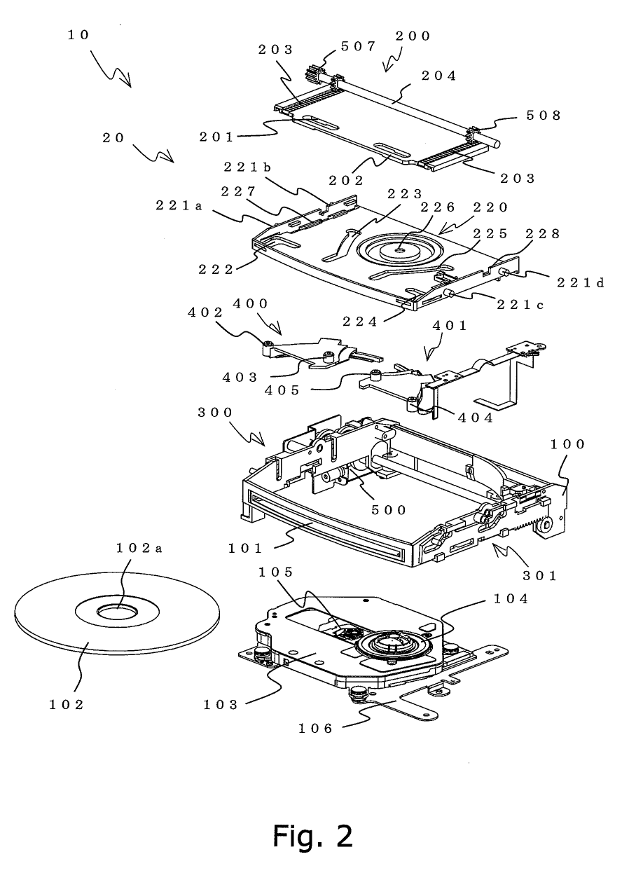

As shown in FIGS. 1 and 2, an external frame (frame portion) 100 of the optical disc drive apparatus 10 is formed such that an outer peripheral portion of a drive fixing frame 106 made of metal is covered with a frame made of a synthetic resin. The external frame 100 has a substantially a rectangular shape. The optical disc drive apparatus 10 has a thin structure having a thickness (height) of 24.4 mm. The maximum width W is 110.75 mm, and the maximum length D is 89.5 mm.

The disc insertion opening 101 of the external frame 100 as shown in FIG. 2, is formed so as to have an opening width to fit the diameter of the optical disc 102. A skirt portion (not shown) is attached to above and below the disc insertion opening 101. The skirt portion is formed by using materials having appropriate frictional force and elasticity and holds the upper and lower surfaces of the optical disc 102 elastically.

To the central further side of the disc insertion opening 101 of the external frame 100 as shown in FIG. 2, a spindle motor (not shown) is attached upward along the substantially horizontal direction. The spindle motor is placed to a substantially central portion of the disc insertion side of an optical pickup unit base (not shown) to which an optical pickup 105 is placed. The optical pickup unit base (not shown) is placed at the lowest position of the drive fixing frame 106 with a plurality of insulators (not shown) being interposed therebetween and along the substantially horizontal direction. On the outer peripheral portion of the spindle motor which is placed upward, the turntable 104 is adhered along the substantially horizontal direction. At the central portion of the turntable 104, a boss for centering having a conical and trapezoidal shape is integrally formed.

Above the optical pickup unit base, and on the further side of the spindle motor, the optical pickup 105 is provided. The optical pickup 105 includes an objective lens which is pick up means for recording and reproducing video and other information on a recording surface which is a lower surface of the optical disc. The objective lens is incorporated to a central portion inside a thread placed along substantially horizontal direction in an opening formed on the side further than the optical pickup 105 and the like so as to face upward along the substantially vertical direction. The thread is guided by a guide main shaft (not shown) and guide sub shaft (not shown) which are provided above the optical pickup unit base and along the substantially horizontal direction which is parallel to both sides of the opening. The thread is formed so as to be seek passed in the radial direction of the optical disc 102 by a lead screw (not shown) which is controlled to rotate by a thread motor (not shown).

### [Loading Mechanism 20]

As shown in FIGS. 1 through 5, the loading mechanism 20 is formed to include a right arm (arm member) 400 and a left arm (arm member) 401 for holding the outer peripheral portion of the disc, a disc holder 220, a rail plate (substrate) 200 for synchronizing the right arm 400 and the left arm 401 in parallel, and a spring (not shown) for applying a certain tension.

As shown in FIG. 2, the disc holder 220 includes right disc holder grooves 222 and 223 and left disc holder grooves 224 and 225 for guiding the right arm 400 and the left arm 401 in the disc insertion direction.

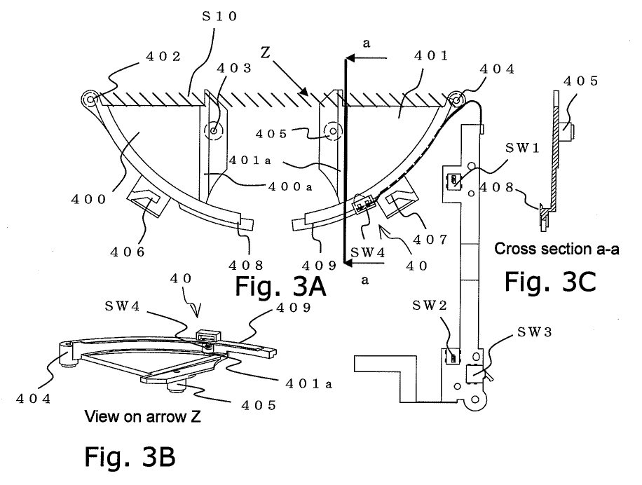

As shown in FIGS. 2 and 3A through 3C, the right arm 400 and the left arm 401 respectively include substantially circular holding portions 408 and 409 which abut only to a non-recording surface of the outer peripheral portion of the optical disc 102, guiding ribs, right arm bosses (boss portions) 402 and 403, left arm bosses (boss portions) 404 and 405, a right arm groove (retraction mechanism) 406, and a left arm groove (retraction mechanism) 407. As shown in FIG. 3A, a spring (biasing member) S10 is bridged between the right arm boss 402 and the left arm boss 404.

As shown in FIG. 2, the disc holder 220 includes the right disc holder grooves (second grooves) 222 and 223, and left disc holder grooves (second grooves) 224 and 225, and ribs 227 and 228 for guiding the rail plate 200 on right and left sides. On surfaces of the right and left sides, bosses (ribs) 221a and 221b and bosses (ribs) 221c and 221d which protrude outside for moving in a direction substantially vertical with respect to the disc surface direction (upward and downward direction) are provided respectively. In the center of the disc holder 220, a disc damper 226 which is required for holding the optical disc 102 is provided. The disc damper 226 is held at a hole portion which is formed to prevent falling. The right disc holder groove 222 and the left disc holder groove 224 are formed so as to fit the right arm boss 402 and the left arm boss 404, and also to include a groove substantially parallel to the disc insertion direction and a groove substantially orthogonal thereto. Similarly, the right disc holder groove 223 and the left disc holder groove 225 are formed so as to fit the right arm boss 403 and the left arm boss 405, and also to include a groove substantially parallel to the disc insertion direction, a groove forming a certain angle therewith and a groove substantially orthogonal thereto.

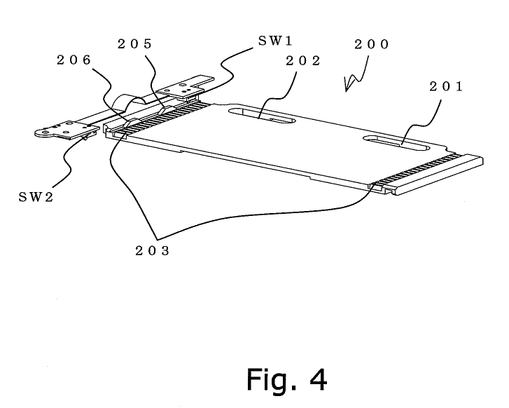

As shown in FIG. 2, the rail plate 200 includes a right rail plate groove (first groove) 201 and a left rail plate groove (first groove) 202 formed along a direction substantially orthogonal to the disc insertion direction in the disc surface direction, which are located symmetrically in the right and left direction. The disc holder 220 includes guide ribs (not shown) located at the right and left sides in substantially parallel to the disc sliding direction. On a top surface of the rail plate 200, rail plate racks 203 are formed on the right and left sides. As shown in FIG. 4, a disc ejecting completed position rib 205 and a disc insertion completed position rib 206 are formed on the left side of the rail plate 200.

As shown in FIG. 2, the disc damper 226 is located between the disc holder 220 and the rail plate 200 in order to fix the optical disc 102. The disc damper 226 includes a flange which is for preventing from falling from the gap thereto, and incorporates a yoke. Further, the disc damper 226 is formed so as to prevent the optical disc 102 from touching the disc holder 220 and/or the rail plate 200 when it clamps the optical disc 102.

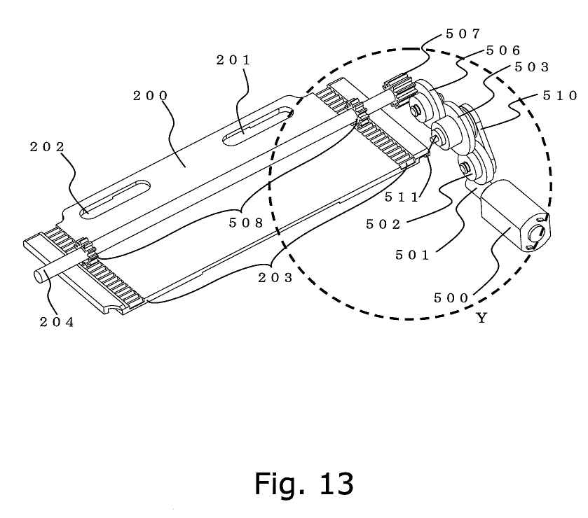

When the optical disc 102 is inserted, as shown in FIGS. 5, 6, 7A, 7B, and 8, the optical disc 102 is slid and inserted along the substantially horizontal direction (loading direction) by an external force (e.g., a hand of a person, or the like) to position 1, which will be described later in more detail, with the recording surface of the optical disc 102 being protected by a skirt portion (not shown) attached to the disc insertion opening 101. The right arm 400 and the left arm 401 hold only the outer peripheral portion of the optical disc 102 without touching the recording surface of the optical disc 102. When the switch SW4 (see FIGS. 3A and 3B) incorporated into the left arm 401 detects a disc-in state of the optical disc 102, an idler gear 503 rotates to a position where it does not engage with a gear 507 (see FIG. 13).

### [Disc Clamp Mechanism 30]

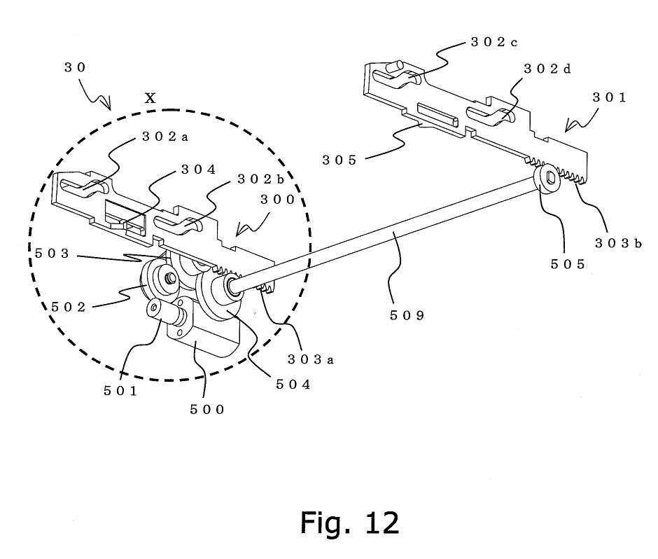

The disc clamp mechanism 30 is a mechanism for moving the disc holder 220 in a direction perpendicular to the disc insertion direction to move the optical disc 102 in a direction perpendicular to the disc surface (upward and downward direction). As shown in FIGS. 12, 13 and the like, the disc clamp mechanism 30 is formed to include a right rod (rod portion) 300 and a left rod (rod portion) 301, a gear 504 and a gear 505 for moving these rods in parallel, a synchronization axis 509, an idler arm 510, a gear 502, a worm gear 501, and a loading motor (moving mechanism, ejecting mechanism) 500.

The right and the left rods 300 and 301 have rod grooves (third grooves) 302a, 302b, 302c, and 302d formed so as to move the optical disc 102 in the upward and downward direction which is perpendicular to the disc insertion direction. The rod grooves 302a, 302b, 302c, and 302d fit to the bosses 221a, 221b, 221c, and 221d formed on the side surfaces of the disc holder 220.

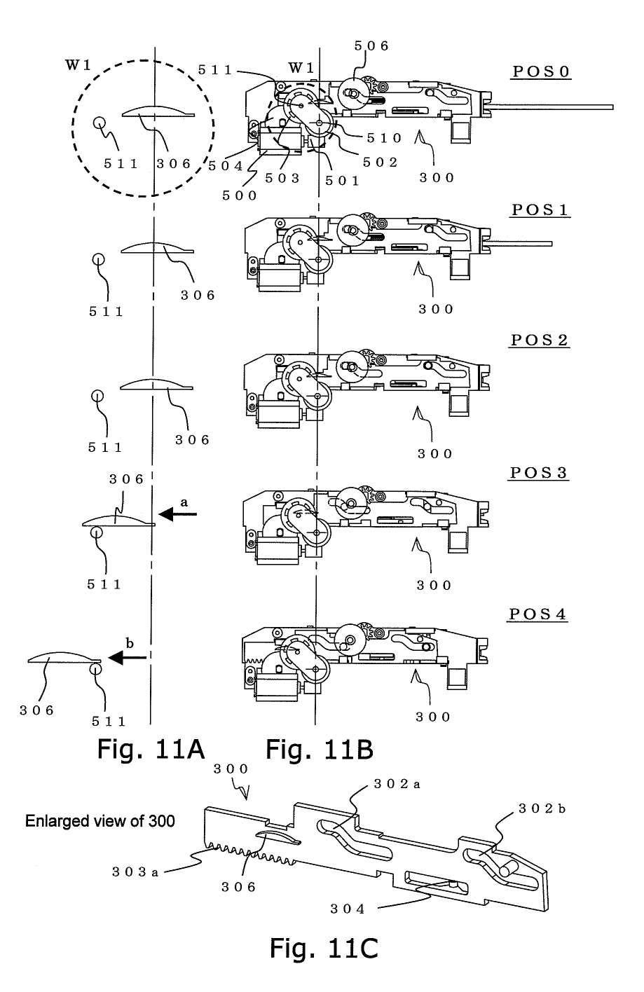

The right and the left rods 300 and 301 further include a right rod rack 303a and a left rod rack 303b for moving substantially parallel to the disc insertion direction which are formed on respective lower end surfaces. Further, the right rod 300 includes a stopper 306 (see FIGS. 11A through 11C) for restraining rotation of the idler arm 510.

As shown in FIG. 12, the synchronization axis 509 is press-fitted to the gear 504 and the gear 505. The right and the left rods 300 and 301 move in substantially parallel with respect to each other.

An idler is set to the idler arm 510, and an idler spring and an idler gear 503 are press-fitted to a certain depth with respect to an idler arm shaft 511. Rotation of the idler arm 510 and rotation of the idler gear 503 have opposite rotation directions caused by the rotation of the loading motor 500 with the idler spring being provided. The idler arm 510 is rotated by the rotation of the loading motor 500. Thus, the idler gear 503 is controlled by providing the stopper 306 for preventing rotation on the right rod 300.

### (Disc Detection Section 40)

The disc detection section 40 includes a left arm (arm member) 401 which can move along the outer peripheral portion of the optical disc 102 in accordance with the disc loading operation, and a switch (disc detection element) SW4 for determining a disc which is located in a position of the holding portion 409 of the left arm 401 which opposes the outer peripheral portion of the optical disc 102. The left arm 401 is a part of the mechanism for loading and ejecting the optical disc 102 and also functions as a part of the disc detection section 40. The switch SW4 employs, for example, a micro switch which is turned on/off by contact/non-contact to the outer peripheral portion of the optical disc 102. When the switch SW4 touches the outer peripheral portion of the optical disc 102, it is turned on, and when it is moved away from the outer peripheral portion, it is turned off.

### <Structure of Control Device 50>

As shown in FIG. 26, the control device 50 includes a control section 70 formed of microcomputer having, for example, CPU, RAM, ROM, I/O interface and the like. The control section 70 controls the optical disc drive 103 and also controls the loading/ejecting operation and clamp operation of the loading motor 500. To the control section 70, a spindle motor (SM) 80 of the optical disc drive 103, a voice coil motor (VCM) 81 for driving the optical head, and a drive circuit 71 of the loading motor (LM) 500 are connected. To the control section 70, other input and output sections including an input section including the switches SW1 through SW4 and other switches and an output section such as display section are connected.

### <Operation Upon Disc Insertion>

### (Description of Positions)

First, positions (POS) 0 through 4 in the step of inserting the optical disc 102 will be described below with reference to FIGS. 5 through 7B and 11A through 11C and the like.

Herein, while the operation of disc loading, movement from position 0 to position 2 is referred to as the disc inserting operation, and movement from position 2 to position 4 is referred to as disc clamping operation. On the other hand, when the disc is being ejected, movement from position 4 to position 2 is referred to as disc clamp releasing operation, and movement from position 2 to position 0 is referred to as disc ejecting operation.

### (Position 0)

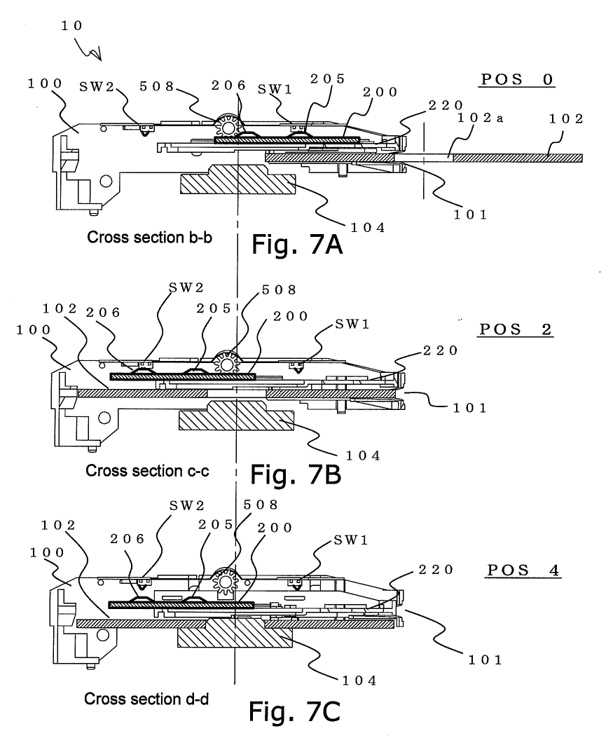

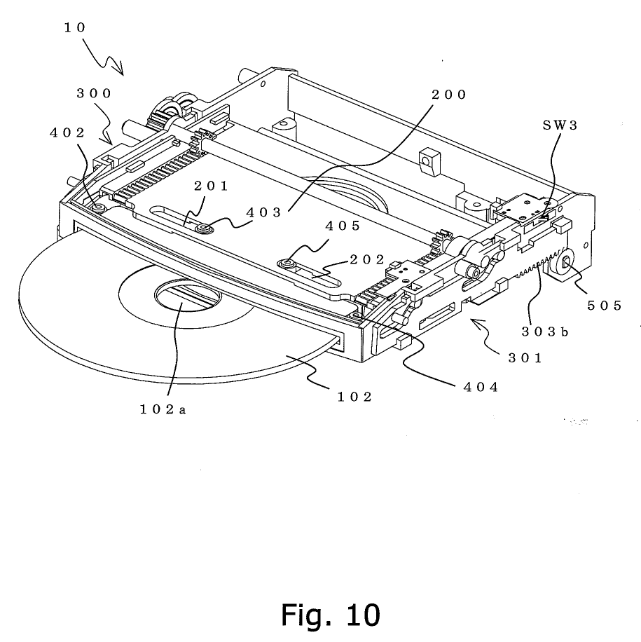

As shown in FIGS. 5 and 10, at position 0, the optical disc 102 is to be inserted or has been ejected. As shown in FIG. 7A, the switch SW1 abuts the disc ejecting completed position rib 205 formed on the rail plate 200.

### (Position 1)

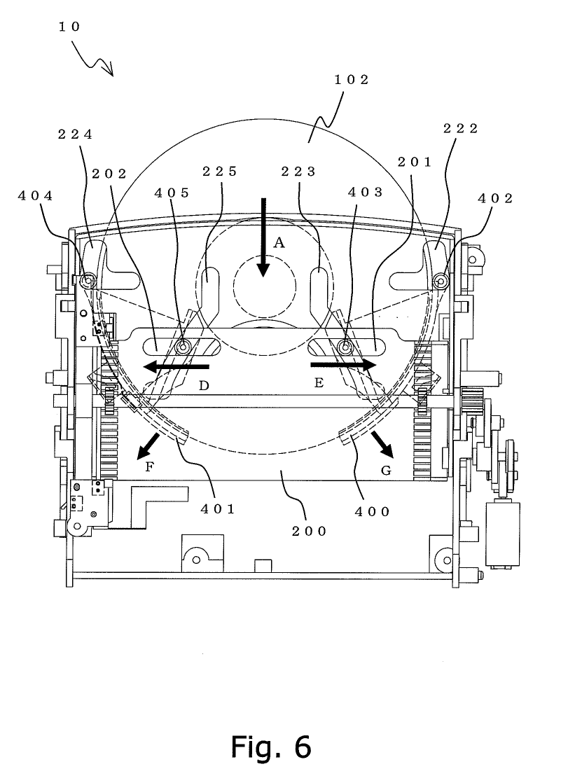

At position 1, the optical disc 102 is being inserted in direction A as shown in FIGS. 5 and 6 manually or the like until the optical disc 102 abuts the switch SW4 incorporated in the left arm 401. As shown in FIG. 6, as the optical disc 102 moves, the right arm boss 402 and the left arm boss 404 are pushed to spread to a width equal to the diameter of the optical disc 102 along the right disc holder grooves 222 and 223 and the left disc holder grooves 224 and 225 of the disc holder 220.

For rotating the right arm 400 and the left arm 401 in synchronization, the right rail plate groove 201 and the left rail plate groove 202 formed so as to be orthogonal to the loading direction in the horizontal direction are formed on the rail plate 200. The right arm boss 403 and the left arm boss 405, which move in directions B and C as shown in FIG. 5 along the right disc holder groove 223 and the left disc holder groove 225, also fit to the right rail plate groove 201 and the left rail plate groove 202.

With such a structure, as the right arm 400 and the left arm 401 rotates in directions F and G in FIG. 6 in synchronization with disc insertion, the rail plate 200 slides in direction A as shown in the figure. The disc ejecting completed position rib 205 formed on the rail plate 200 is moved away from the switch SW1, and the tension of the spring S10 (see FIG. 3A) bridged between the right arm boss 402 of the right arm 400 and the left arm boss 404 of the left arm 401 is maximized.

### (Position 2)

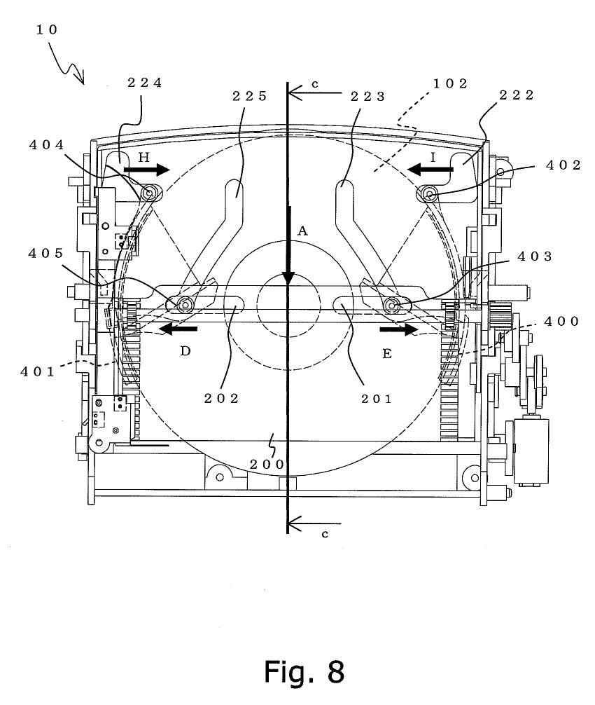

At position 2, by the tension of the spring S10 (see FIG. 3A) bridged between the right arm boss 402 and the left arm boss 404, as shown in FIG. 8, the optical disc 102 moves in a horizontal direction so as to be drawn into until the position of the central hole 102a of the optical disc 102 comes above the axis of the turn table 104. The distance b000etween the right arm 400 and the left arm 401 becomes maximum, and they move to the position where the optical disc 102 is completely interposed from the right and left sides.

With such a structure, for inserting a disc, the optical disc 102 may be pushed in until the diameter portion passes by between the right arm boss 402 and the left arm boss 404, and then, the optical disc 102 can be drawn into the optical disc drive apparatus 10 by the tension of the spring S10.

On the contrary, for ejecting the disc, the optical disc 102 may be pushed out until the diameter portion passes by between the right arm boss 402 and the left arm boss 404, and then, the optical disc 102 can be pushed outside the optical disc drive apparatus 10 by the tension of the spring S10.

As shown in FIG. 7B, the switch SW2 abuts the disc insertion completed position rib 206 formed on the rail plate 200, and the rail plate rack 203 of the rail plate 200 and the gear 508 engages each other.

### (Position 3)

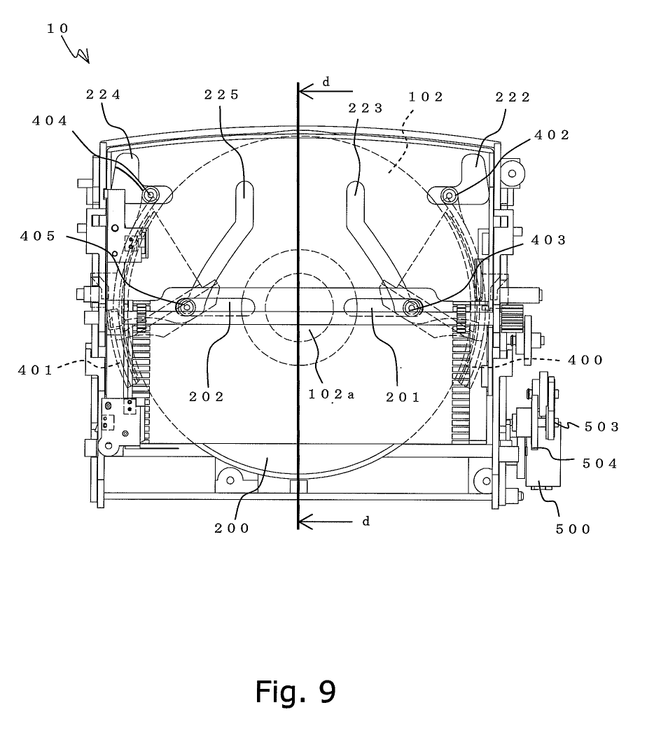

As shown in FIG. 9, at position 3, the loading motor 500 rotates, and the idler gear 503 and the gear 504 engage each other, and the disc holder 220 moves in the upward and downward direction which is orthogonal to the disc insertion direction. Then, the optical disc 102 is placed on the turntable 104.

Since the disc holder 220 moves downward, the disc insertion completed position rib 206 formed on the rail plate 200 and the disc insertion completed detection switch SW2 moves from the abutting state as shown in FIG. 7B to the separate state as the disc holder 220 moves in the upward and downward direction.

### (Position 4)

At position 4, after movement of the optical disc 102 in the direction orthogonal to the disc insertion direction (upward/downward) direction is completed, the right rod 300 and the left rod 301 slide in the disc insertion direction. Then, the right arm groove 406 and the left arm groove 407 formed on the right arm 400 and the left arm 401 fit to the right rod boss (retraction mechanism) 304 and the left rod boss (retraction mechanism) 305.

In this way, the right arm 400 and the left arm 401 slide to move away from the optical disc 102, and the switch SW3 and the end surface of the right rod 300 abut each other (i.e., the switch SW3 is turned on) to clamp the optical disc 102.

### (Disc Insertion)

For actually inserting the optical disc 102, as shown in FIGS. 5 through 7C, the right arm boss 402 and the left arm boss 404 of the right arm 400 and the left arm 401 slide in the disc insertion direction with being fitted to the right disc holder groove 222 and the left disc holder groove 224 of the disc holder 220, respectively. Then, as shown in FIG. 6, the right arm boss 402 and the left arm boss 404 slide along the direction orthogonal to the insertion direction with being fitted to the right disc holder groove 222 and the left disc holder groove 224 of the disc holder 220. Then, the right arm boss 402 and the left arm boss 404 slide in the direction such that they move away from each other (directions F and G in FIG. 6) as they move along the outer peripheral portion of the optical disc 102. During this operation, the right arm boss 402 and the left arm boss 404 receives a certain repulsive force inward from the spring S10 (see FIG. 3A) located above.

On the other hand, the right arm boss 403 and the left arm boss 405 slide along the shape of the grooves from directions B and C as shown in FIG. 5 with being fitted to the right disc holder groove 223 and the left disc holder groove 225 formed so as to form a certain angle with respect to the disc insertion direction.

The right arm 400 and the left arm 401 rotate so as to follow the outer peripheral portion of the optical disc in synchronization with the right rail plate groove 201 and the left rail plate groove 202 formed on the rail plate 200. When the right arm boss 402 and the left arm boss 404 pass by the portion where a portion which corresponds to its diameter of the optical disc 102 is interposed (see FIG. 6), the load applied to the spring provided on the right arm boss 402 and the left arm boss 404 becomes maximum. Then, after the right arm boss 402 and the left arm boss 404 pass by the portion of the optical disc 102 which corresponds to its diameter as shown in FIG. 6, they move in the directions indicated by arrows H and I (inside) in FIG. 8 along the right disc holder groove 222 and the left disc holder groove 224 by the tension of the spring S10.

Next, the right arm boss 403 and the left arm boss 405 slide along the right disc holder groove 223 and the left disc holder groove 225. At the same time, the rail plate 200 also moves in direction A shown in FIG. 8 in the horizontal direction in synchronization with the movement of the right arm boss 403 and the left arm boss 405.

Until the central hole 102a of the optical disc 102 moves to position 2 on the axis of the turntable 104, the right arm 400 and the left arm 401 slide in the horizontal direction by the spring tension. At the same time, as shown in FIG. 7A, the switch SW1 located above the disc holder 220 is switched from on to off since the rail plate 200 moves and the disc ejecting completed position rib 205 is removed away from the switch SW1. On the other hand, as shown in FIG. 7B, the switch SW2 located on the external frame 100 is switched from off to on since the disc insertion completed position rib 206 of the rail plate 200 abuts thereto.

### <Disc Clamping Operation>

In the disc clamping operation, for converting the movement direction of the optical disc 102 moved to position 2 from the movement in the horizontal direction to the movement in the upward/downward direction, the control section 70 issues a drive command to the loading motor 500 after position 2 is detected. The loading motor 500 which receives the drive command rotates the idler gear 503 through the worm gear 501 and the gear 502.

During such an operation, due to rotation of the loading motor 500, the idler gear 503 which incorporates a spring is shaken to a certain direction and engages with the gear 504. The gears 504 and 505 are press-fitted to the synchronization axis 509, and engage with the right rod rack 303a and the left rod rack 303b to move in synchronization in substantially parallel to the disc insertion direction.

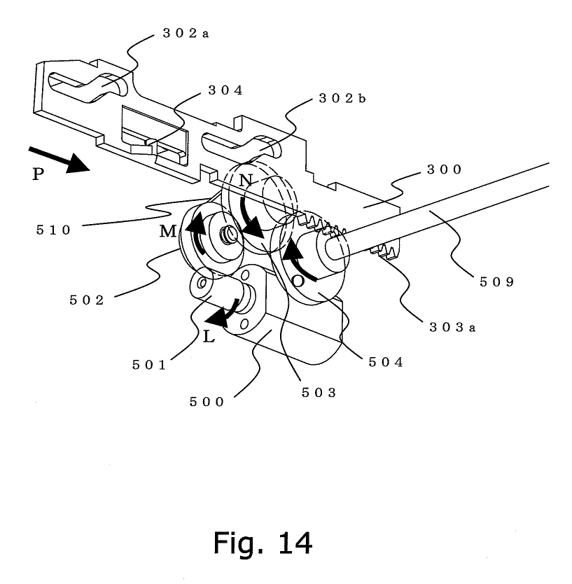

FIG. 14 is an enlarged view of dotted circle X shown in FIG. 12 and is a perspective view for illustrating operations of the loading motor 500, the idler gear 503, and the right rod 300. The loading motor 500 rotates in a direction indicated by arrow L causing the worm gear 501 to rotate in the direction indicated by arrow L.

Since the worm gear 501 rotates in the direction indicated by arrow L, the gear 502 which engages with the worm gear 501 rotates in the direction indicated by arrow M. Since the gear 502 rotates in the direction indicated by arrow M, the idler arm 510 rotates in the direction toward the gear 504, and the idler gear 503 located on the idler arm 510 abuts and engages with the gear 504. The idler gear 503 rotates in the direction indicated by arrow N, causing the gear 504 to rotate in the direction indicated by arrow O. Therefore, the synchronization axis 509 and the gear 505 rotate in the direction indicated by arrow O with the gear 504. The rotation of the gear 504 in the direction indicated by arrow O causes the right rod 300 to slide in the direction indicated by arrow P via the right rod rack 303a.

Similarly, the rotation of the gear 505 in the direction indicated by arrow O causes the left rod 301 to slide in the direction indicated by arrow P via the left rod rack 303b (not shown).

Since the right and left rods 300 and 301 move in the direction indicated by arrow P, i.e., the disc insertion direction, the bosses 221a and 221b and the bosses 221c and 221d of the disc holder 220 move in the direction orthogonal to the disc insertion direction, i.e., the direction of the turn table 104 (hereinafter, referred to as clamping direction) being guided by a pair of guide grooves 102a and 102b and another pair of guide grooves 102c and 102d along the rod grooves 302a and 302b and the rod grooves 302c and 302d of the right and left rods 300 and 301. At the same time, the rail plate 200 held by the disc holder 220 also moves in the clamping direction. Thus, the disc insertion completed position rib 206 of the rail plate 200 is moved away from the switch SW2 and turned off to become the state of position 3. As a result, the disc holder 220 can be moved in the direction perpendicular with respect to the disc insertion direction (upward/downward direction). Therefore, the optical disc 102 can be held by the disc damper 226 substantially at the same time as it is loaded to the turntable 104 (position 3).

At position 3, the optical disc 102 is held by the right arm 400 and the left arm 401. Thus, it has to be released. Furthermore, since the right rod 300 and the left rod 301 move in the disc insertion direction, the right rod boss 304 and the left rod boss 305 respectively fit to the right arm groove 406 and left arm groove 407. Therefore, the right arm 400 and the left arm 401 slide in the direction such that they move away from the optical disc 102.

At this time, if the end surface of the left rod 301 detects the switch SW4 located on the external frame 100, a signal STOP is sent to the loading motor 500 and a series of operations is finished (position 4). As shown in FIG. 7C, at position 4, the switch SW2 and the disc insertion completed position rib 206 are moved away from each other, and the optical disc 102 is clamped at the turntable 104. The end surface of the left rod 301 abuts the switch SW3, and the operation can be shifted to reading of information written on the optical disc 102.

### <Operation for Ejecting Disc>

As described above, for inserting the optical disc 102, the external force and the tension of the spring are applied in the substantially horizontal direction and the power of the loading motor 500 is applied in the substantially vertical direction as shown in FIG. 9 and the like. On the other hand, for ejecting the optical disc 102, the power of the loading motor 500 is applied. If an operation simply opposite to the one for inserting a disc is performed in the disc loading mechanism, the optical disc 102 cannot be ejected. Thus, a gear 506, a gear 507, a gear 508, 508 and a synchronization axis 204 are added to the disc loading mechanism to provide ejecting function.

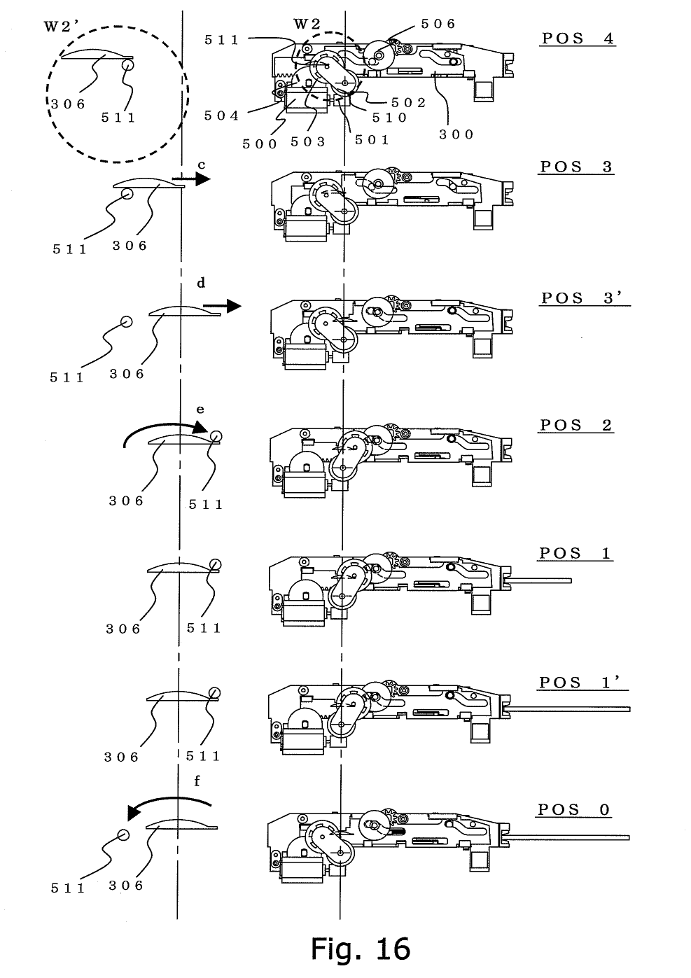

As shown in FIG. 16, an operation for ejecting a disc include an operation for releasing clamp of the disc and an operation for ejecting the disc. The operation for ejecting a disc is completed by performing the above two operations in series.

### <Disc Clamp Releasing Operation>

With reference to FIG. 14, in the disc clamp releasing operation, an eject button is pressed and the loading motor 500 rotates in the direction opposite to that in the disc clamping operation. Thus, the worm gear 501 rotates in the direction opposite to the direction indicated by arrow L and the gear 502, which engages with the worm gear 501, rotates in the direction opposite to the direction indicated by arrow M. The idler gear 503 placed on the idler arm 510 causes the idler arm 510 to rotate toward the gear 506 as the worm gear 502 rotates in the direction opposite to the direction indicated by arrow M.

If the idler gear 503 is disengaged from the gear 504, the right and left rods 300 and 301 cannot be moved in the direction opposite to arrow P, and the disc clamp releasing operation cannot be performed. Thus, the stopper 306 for preventing the rotation of the idler arm 510 is provided on the right rod 300. The stopper 306 restricts the idler arm shaft 511 so as to prevent the idler arm 510 from rotating in a reverse direction, and hold the idler gear 503 and the gear 504 in engagement in order to enable the disc clamp releasing operation from position 4 to position 2. Since the gear 505 rotates in the direction opposite to arrow O, the left rod 301 similarly slides in the direction opposite to arrow P via the rod rack 303b.

Now, with reference to FIG. 16, movement of the idler arm 510 and the stopper 306 for releasing disc clamp is described in more detail.

The loading motor 500 rotates in the direction opposite to that in the disc clamping operation from position 4, causing the right rod 300 to slide in the direction of arrow c and the switch SW3 to be turned off. In other words, the members move toward position 3. At position 3, the right rod 300 further moves in the direction of arrow d, and at the position where the right rod 300 does not restrain the idler arm shaft 511 by the stopper 306, i.e., at position 3′, the idler arm 510 rotates in the direction of arrow e and moves to position 2. In this way, the disc clamp releasing operation is completed, and then the disc ejecting operation is started.

### <Disc Ejecting Operation>

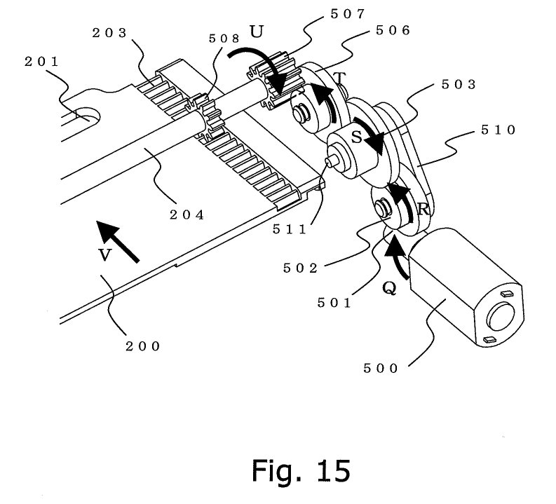

The disc ejecting operation will be described in more details with reference to FIG. 15. FIG. 15 is an enlarged view of dotted circle Y in FIG. 13 for illustrating operations of the loading motor 500 and the gears.

As shown in FIG. 15, as the loading motor 500 rotates in the direction indicated by arrow Q, the worm gear 501 rotates in the direction indicated by arrow Q and the gear 502 rotates in the direction indicated by arrow R. Then, the idler gear 503 which engages with the gear 502 rotates in the direction indicated by arrow S and engages with the gear 506.

The rotation of the idler gear 503 causes the gear 506 to rotate in the direction indicated by arrow T, and the synchronization axis 204 and the gear 508 to rotate in the direction indicated by arrow U via the gear 507. On the rail plate 200, the rail plate rack 203 which engages with the gear 508 for sliding the rail plate 200 is provided. As the gear 508 rotates in the direction indicated by arrow U, the rail plate 200 slides in the direction indicated by arrow V.

Now, with reference to FIG. 16, movement of the idler arm 510 for ejecting the disc is described in detail.

At position 2, the idler arm 510 is deflected toward the gear 506, and the idler gear 503 and the gear 506 engage with each other.

When the loading motor 500 rotates in such a state, the rail plate 200 starts to slide in the disc insertion opening direction. As the rail plate 200 slides, the disc insertion completed position rib 206 formed on the rail plate 200 and the switch SW2 move away from each other to become the state of position 1.

When the loading motor 500 moves in the state of position 1, the rail plate 200 finishes sliding at the disc insertion opening and enters the state of position 1′. When the rail plate 200 reaches the disc insertion opening, the disc ejecting completed position rib 205 formed on the rail plate 200 and the switch SW1 abut each other.

When it is detected that the switch SW1 is turned on, the loading motor 500 is rotated in the direction opposite to the disc ejecting direction for a predetermined time period to deflect the idler arm 510 toward the gear 504. The idler gear 503 is moved away from the gear 506 and is engaged with the gear 504 to be in the state of position 0.

At position 0, the gear 506 becomes free, and the rail plate 200 becomes movable by the tension of the spring member when a disc is inserted next time.

The disc ejecting operation is completed, and the center hole 102a of the optical disc 102 is exposed outside the disc insertion opening 101 and the disc ejecting operation is finished.

As described above, by using two arms, i.e., right and left arms 400 and 401, a small and light optical disc drive apparatus 10 of the slot-in type which enables the optical disc 102 to be ejected to the position where a finger can be inserted into the center hole 102a and which includes a loading mechanism 20 from the disc insertion opening 101 to the turn table 104 can be achieved.

By employing two arms (the right arm 400 and the left arm 401) which are given the spring tensions in the direction that their ends pull each other, the optical disc 102 can be ejected to the position where a finger can be inserted into the central hole 102a of the optical disc 102 as shown in FIGS. 5 and 10. Without incorporating many number of parts including a plurality of rollers and the like, the small, thin and light optical disc drive apparatus 10 comprising the loading mechanism 20 and the disc clamping mechanism 30 which moves the optical disc 102 from the disc insertion slot to the turn table 104 can be achieved.

### <Disc Detection Operation>

Now, movement of the switch SW4 attached to the left arm 401 as shown in FIG. 6 in the optical disc drive apparatus 10 of the slot-in type, which employs the right and left arms 400 and 401 and includes the loading mechanism 20 from the disc insertion opening 101 to the turn table 104 as described above, will be described in more detail.

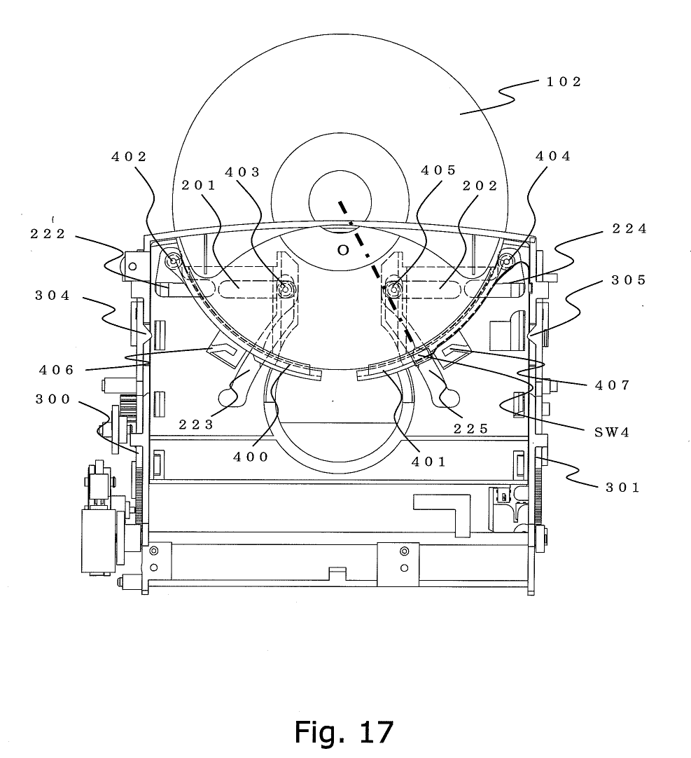

FIG. 17 is a view from the bottom surface side of the optical disc drive 103 in the state of position 0 (see FIG. 5).

The optical disc 102 is inserted from the disc insertion opening 101. When it abuts the left arm 401 having a substantially arc shape, the switch SW4 for disc detection is turned on. The line between the center of the optical disc 102 and the outer peripheral portion of the optical disc 102 which abuts the switch SW4 is indicated by O.

In the state of position 0, the rail plate 200 has not yet started to slide in the insertion direction. Thus, as shown in position 0 of FIG. 7A, the switch SW1 abuts the disc ejecting completed position rib 205 and is on.

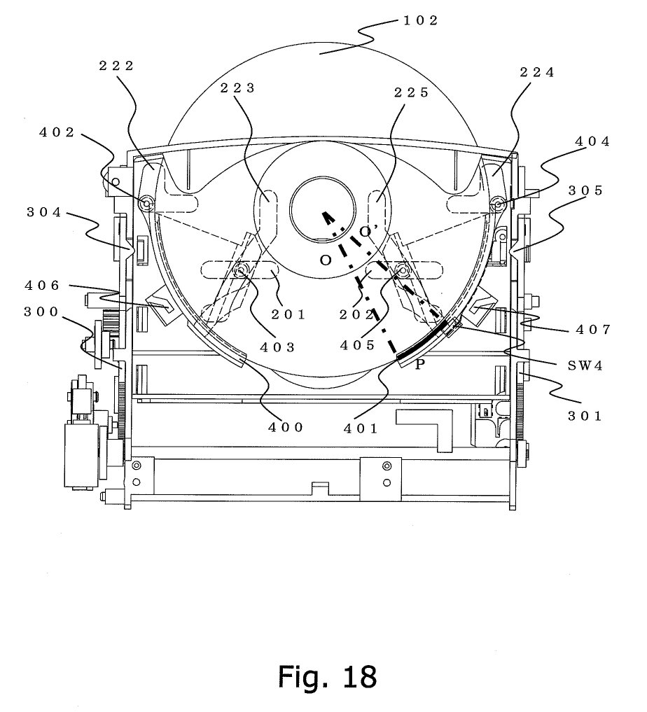

In the state as shown in FIG. 17, when the optical disc 102 is pushed in the insertion direction, the state of position 1 (FIG. 6) is obtained as described above. FIG. 18 is a diagram viewed from the bottom surface side of the optical disc drive 103 in the state shown in FIG. 6.

As shown in FIG. 18, when the optical disc 102 moves from position 0 to position 1, the switch SW4 slides along the outer peripheral portion of the optical disc 102 from the position defined by line O to the position defined by line O′. The track of the movement of the switch SW4 is referred to as P.

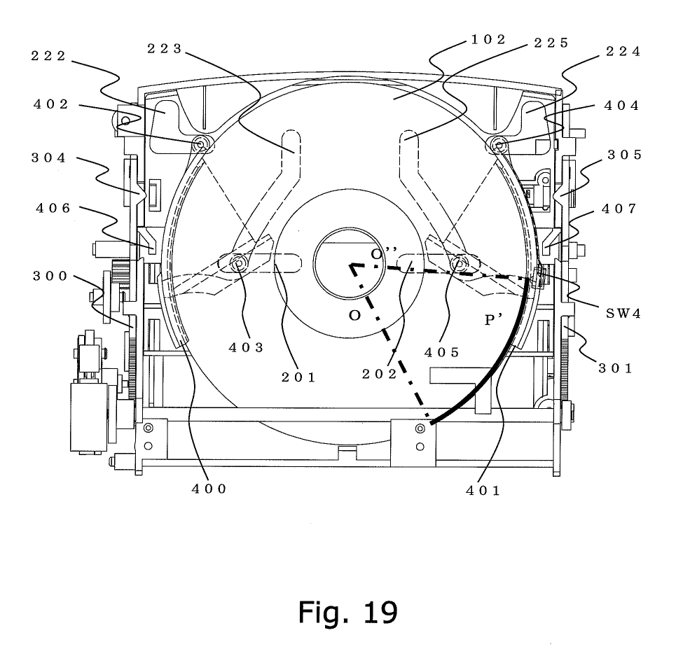

When the optical disc 102 is further inserted, the optical disc 102 reaches to position 2 (FIG. 8) as described above. FIG. 19 is a diagram viewed from the bottom surface side of the optical disc drive 103 in the state as shown in FIG. 8.

As shown in FIG. 19, when the optical disc 102 moves from position 0 to position 2, the switch SW4 slides along the outer peripheral portion of the optical disc 102 from the position defined by line O to the position defined by line O″. The track of the movement of the switch SW4 is referred to as P′. As the switch SW4 moves from the start position of disc insertion (position 0) to the disc insertion completed position (position 2), the switch SW4 slides along the outer peripheral portion of the optical disc 102 by distance P′. During this movement, the switch SW4 remains on. If the inserted disc is an irregular shaped disc, the switch SW4 is turned off while it slides along distance P′. Thus, the control section 70 can easily determine whether the inserted disc is an irregular shaped disc or not.

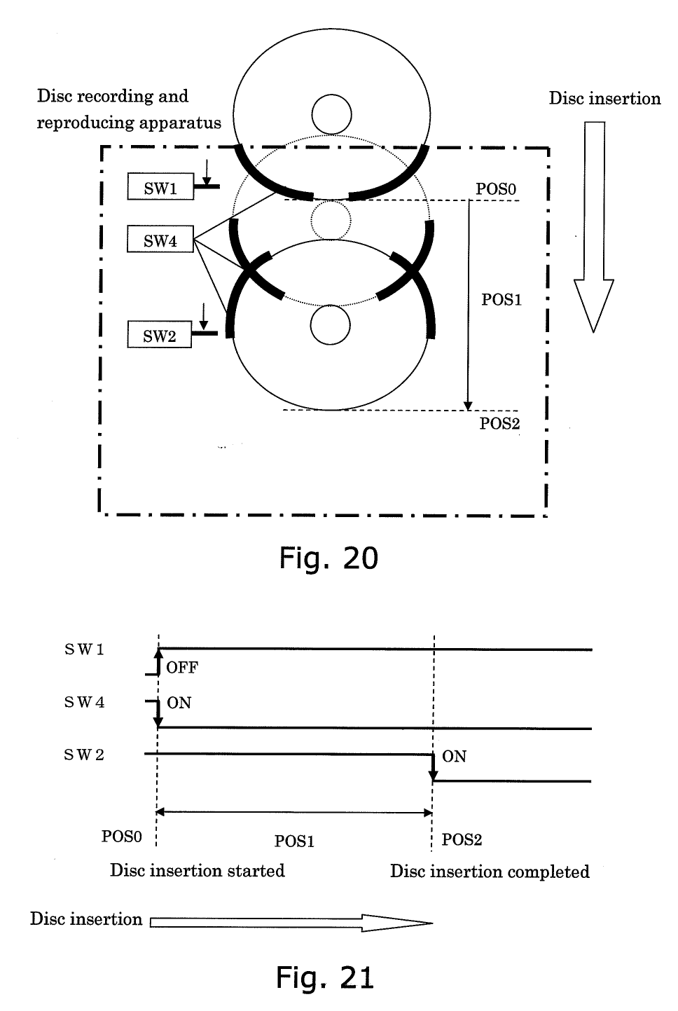

FIG. 20 is a schematic diagram showing the loading operation when a standard disc is inserted into the optical disc drive apparatus 10 according to the present embodiment. As the optical disc 102 is inserted from the disc insertion opening 101, the disc position changes from position 0 to position 1, and then to position 2.

FIG. 21 is a timing chart showing when the switch SW1, switch SW2, and the switch SW4 are turned on in the above operation.

As shown in FIG. 21, if the switch SW4 remains on after the switch SW1 is turned off and until the switch SW2 is turned on, the control section 70 can determine that the optical disc 102 has a standard circular shape.

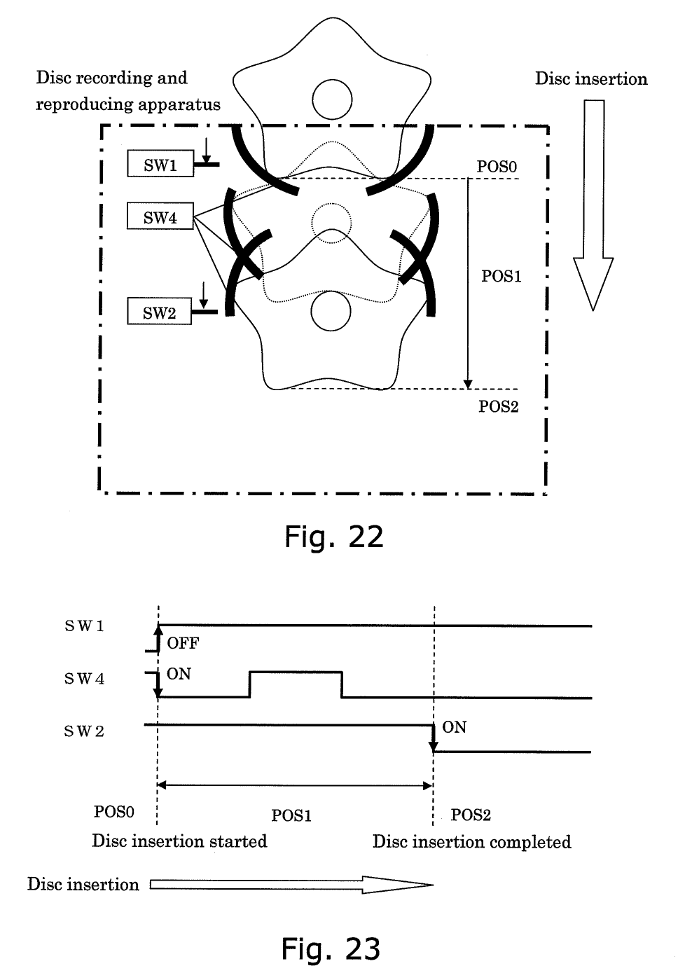

On the other hand, as shown in FIGS. 22 and 23, when an irregular shaped disc 102′ is inserted, the switch SW4 is turned off after the switch SW1 is turned off and until the switch SW2 is turned on. Accordingly, the control section 70 can determine that the inserted optical disc has an irregular shape, i.e., does not have a circular shape.

When the control section 70 detects that the irregular shaped disc 102′ is inserted, it immediately performs the disc ejecting operation. In this way, damage to the irregular shaped disc 102′ and disorder of the optical disc drive apparatus 10 can be prevented.

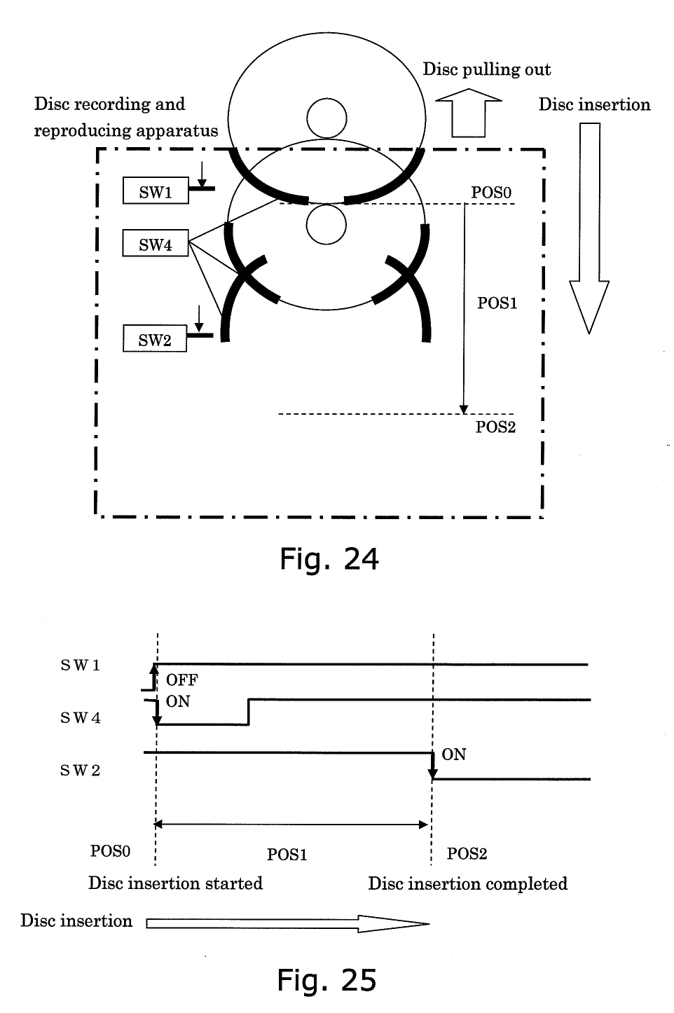

In the optical disc drive apparatus 10 according to the present embodiment, even in an abnormal state caused by pulling out the optical disc 102 in the middle of the disc inserting operation, the switch SW4 is turned off after the switch SW1 is turned off and until the switch SW2 is turned on as in the detection of the irregular shaped disc 102′. Thus, an abnormal state caused by pulling out the disc can be detected. FIGS. 24 and 25 are a schematic diagram and a timing chart in such a case, respectively.

Even when the optical disc 102 is pulled out, as in the case of insertion of the irregular shaped disc 102′, damage to the optical disc 102′ and disorder of the optical disc drive apparatus 10 can be prevented by performing the disc ejecting operation.

### OTHER EMBODIMENTS

One embodiment of the present invention has been described above. However, the present invention is not limited to the above embodiment. Various modifications can be made within the scope of the gist of the present invention.

### (A)

In the above embodiment, a plurality of guiding grooves (right disc holder grooves 222 and 223 and left disc holder grooves 224 and 225) are used for rotating the right and left arms 400 and 401 along the outer peripheral portion of the optical disc 102. However, the present invention is not limited to such an example.

For example, the right and left arms may be rotated by fitting protruded portions or the like instead of using the guiding grooves.

### (B)

In the above embodiment, one spring S10 is used as a biasing member for applying forces in the direction along which the ends of the right and left arms 400 and 401 (arm bosses 402 and 404) pull each other. However, the present invention is not limited to such an example.

For example, two or more springs which separately apply forces to ends of the right and left arms 400 and 401 may be employed as the biasing members. Alternatively, other elastic members such as rubber or the like may be used as the biasing member.

### (C)

In the above embodiment, the disc drive apparatus records/reproduces information on/from optical discs. However, the present invention is not limited to such an example.

For example, the present invention may be applied to various types of disc drive apparatuses which records/reproduces information on/from other types of discs.

### (D)

In the above embodiment, the best mode of the present invention has been described. However, the present invention is not limited to the disc clamping mechanism of the optical disc drive apparatus which records/reproduces information on/from optical discs. The present invention may be applied to any disc drive apparatuses of the slot-in type.

Further, the discs are not limited to the optical discs, and other types of discs such as magnetic discs may be used.

Moreover, the disc drive apparatuses are not limited to the disc drive apparatuses having the recording/reproducing function, and a disc reproducing apparatus of a car navigation system, a car audio system and the like, or a disc drive apparatus for mobile use may be used.

### (E)

In the above embodiment, the optical disc 102 can be held with the left arm 401, which is an example of moving member, and the left arm 401 is used as both the disc detection section and the loading/ejecting mechanism. However, such a member does not have to be used for both purposes.

For example, the moving member may be formed so as not to hold the discs, and to move along the outer peripheral portion of the circular disc while the operation of disc loading performed by the loading/ejecting mechanism.

### (F)

In the above embodiment, the microswitch is used as a disc detection element. However, the disc detection element is not limited to the microswitch.

The detection element may be any sensor or switch as long as it can detect the outer peripheral portion of the disc. For example, it may be an optical sensor, magnetic sensor, or the like.

### INDUSTRIAL APPLICABILITY

The present invention is not limited to the optical disc drive apparatus which records/reproduces information on/from optical discs, and may be widely applicable to the various types of the disc devices which record/reproduce information on/from various types of discs.

1-8. (canceled)

9. A disc drive apparatus, comprising:
a frame portion having a disc insertion opening;
a pair of arm members on right and left sides which rotate along an outer peripheral portion of a disc inserted from the disc insertion opening in accordance with the position of the disc and hold the outer peripheral portion of the disc; and
a biasing member configured to apply forces such that respective ends of the pair of the arm members on the disc insertion opening side pull each other.

10. The disc drive apparatus according to claim 9, further comprising:
a substrate having a first groove formed so as to extend from the disc insertion opening side toward the further side; and
a disc holder which moves in the insertion direction of the disc is inserted as the disc is inserted or removed; and which has a second groove formed in a direction substantially vertical to the insertion direction, wherein
the arm members have a plurality of boss portions which move within the first and the second grooves in a state being fitted to the first and the second grooves.

11. The disc drive apparatus according to claim 9, further comprising:
a pair of rod portions on right and left sides which have a third groove including a step in a direction vertical to a surface of the disc; and
a moving mechanism configured to move the pair of rod portions backward and forward in the insertion direction of the disc, wherein
the disc holder has a rib which protrudes in an insertion direction of a surface direction of the disc and moves in the state being fitted to the third groove.

12. The disc drive apparatus according to claim 9, further comprising:
a retraction mechanism configured to retract the arm members outward in a radial direction of the disc after the disc is shifted to a clamped state.

13. The disc drive apparatus according to claim 9, further comprising:
an ejecting mechanism configured to drive the arm members so as to move the disc from a disc clamping position to a position where a diameter portion of the disc passes between the ends of the pair of arm members on the disc insertion opening side, which are biased by the biasing member.

14. The disc drive apparatus according to claim 9, wherein:
at least one of the pair of arm members on the right and left sides includes a disc detection element for detecting whether there is a gap to the outer peripheral portion of the disc, the disc drive apparatus further comprising:
a disc determination section configured to determine whether the disc has a circular shape or not in accordance with a result of detecting the gap by the disc detection element.

15. The disc drive apparatus according to claim 14, wherein:
the disc detection element is located at a position of at least one of the pair of arm members on the right and left sides which opposes the outer peripheral portion of the disc.

16. The disc drive apparatus according to claim 9, wherein:
the arm member is a member having a substantially arc shape which abuts a non-recording surface of the disc including the outer peripheral portion and can hold the disc, and which moves the disc from the insertion opening to the inside of the device while moving along the outer peripheral portion of the disc during a loading operation.

17. The disc drive apparatus according to claim 10, further comprising:
a pair of rod portions on right and left sides which have a third groove including a step in a direction vertical to a surface of the disc; and
a moving mechanism configured to move the pair of rod portions backward and forward in the insertion direction of the disc, wherein
the disc holder has a rib which protrudes in an insertion direction of a surface direction of the disc and moves in the state being fitted to the third groove.

18. The disc drive apparatus according to claim 10, further comprising:
a retraction mechanism configured to retract the arm members outward in a radial direction of the disc after the disc is shifted to a clamped state.

19. The disc drive apparatus according to claim 11, further comprising:
a retraction mechanism configured to retract the arm members outward in a radial direction of the disc after the disc is shifted to a clamped state.

20. The disc drive apparatus according to claim 10, further comprising:
an ejecting mechanism configured to drive the arm members so as to move the disc from a disc clamping position to a position where a diameter portion of the disc passes between the ends of the pair of arm members on the disc insertion opening side, which are biased by the biasing member.

21. The disc drive apparatus according to claim 11, further comprising:
an ejecting mechanism configured to drive the arm members so as to move the disc from a disc clamping position to a position where a diameter portion of the disc passes between the ends of the pair of arm members on the disc insertion opening side, which are biased by the biasing member.

22. The disc drive apparatus according to claim 12, further comprising:
an ejecting mechanism configured to drive the arm members so as to move the disc from a disc clamping position to a position where a diameter portion of the disc passes between the ends of the pair of arm members on the disc insertion opening side, which are biased by the biasing member.

23. The disc drive apparatus according to claim 10, wherein:
at least one of the pair of arm members on the right and left sides includes a disc detection element for detecting whether there is a gap to the outer peripheral portion of the disc, the disc drive apparatus further comprising:
a disc determination section configured to determine whether the disc has a circular shape or not in accordance with a result of detecting the gap by the disc detection element.

24. The disc drive apparatus according to claim 11, wherein:
at least one of the pair of arm members on the right and left sides includes a disc detection element for detecting whether there is a gap to the outer peripheral portion of the disc, the disc drive apparatus further comprising:
a disc determination section configured to determine whether the disc has a circular shape or not in accordance with a result of detecting the gap by the disc detection element.

25. The disc drive apparatus according to claim 12, wherein:
at least one of the pair of arm members on the right and left sides includes a disc detection element for detecting whether there is a gap to the outer peripheral portion of the disc, the disc drive apparatus further comprising:
a disc determination section configured to determine whether the disc has a circular shape or not in accordance with a result of detecting the gap by the disc detection element.

26. The disc drive apparatus according to claim 13, wherein:
at least one of the pair of arm members on the right and left sides includes a disc detection element for detecting whether there is a gap to the outer peripheral portion of the disc, the disc drive apparatus further comprising:
a disc determination section configured to determine whether the disc has a circular shape or not in accordance with a result of detecting the gap by the disc detection element.

27. The disc drive apparatus according to claim 10, wherein:
the arm member is a member having a substantially arc shape which abuts a non-recording surface of the disc including the outer peripheral portion and can hold the disc, and which moves the disc from the insertion opening to the inside of the device while moving along the outer peripheral portion of the disc during a loading operation.

28. The disc drive apparatus according to claim 11, wherein:
the arm member is a member having a substantially arc shape which abuts a non-recording surface of the disc including the outer peripheral portion and can hold the disc, and which moves the disc from the insertion opening to the inside of the device while moving along the outer peripheral portion of the disc during a loading operation.
